(19) United States
(12) Patent Application Publication
(10) Pub. No.: US 2012/0054836 A1
(43) Pub. Date: Mar. 1, 2012

(54) SERVER AND METHOD FOR ESTABLISHING VIRTUAL PRIVATE NETWORK

(75) Inventors: CHIA-HUNG CHIEN, Tu-Cheng (TW); CHUN-WEN WANG, Tu-Cheng (TW)

(73) Assignee: HON HAI PRECISION INDUSTRY CO., LTD., Tu-Cheng (TW)

(21) Appl. No.: 13/165,406

(22) Filed: Jun. 21, 2011

(30) Foreign Application Priority Data
Aug. 27, 2010 (CN) 201010264783.6

(51) Int. Cl. H04L 9/32; G06F 21/00

(52) U.S. Cl. 726/4

(57) ABSTRACT

A server includes an event schedule module, an authorization manager, and a control module. The event schedule module establishes a meeting schedule. The authorization manager provides an authorization key and a plurality of participant identifications. The control module establishes a virtual private network according to the meeting schedule. The virtual private network groups at least one resource device, and a plurality of clients with the authorization key.

### BACKGROUND

1. Technical Field

The disclosure generally relates to a server and a method for establishing a virtual private network for a meeting.

2. Description of Related Art

In meetings where participants bring their computer or attend the meeting remotely via a network, all computers of the participants must be authorized one by one to access a network-meeting application. It is a waste of time to separately authorize each of the connected computers at a meeting location.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a central server in one embodiment.

FIG. 2 is a flow chart of a method for establishing a virtual private network according to one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

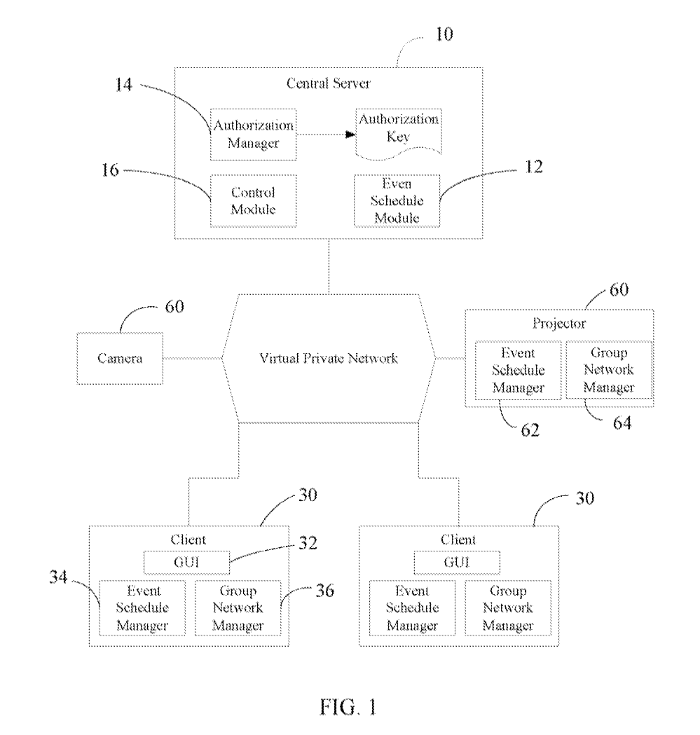

Referring to FIG. 1, in one embodiment, a virtual private network can be established by a central server 10 for allowing a plurality of clients, such as a client 30, to access and operate at least one resource device 60, such as a projector or a camera.

The central server 10 includes an event schedule module 12, an authorization manager 14, and a control module 16.

The event schedule module 12 may store a plurality of meeting schedules. The plurality of meeting schedules may have same or different meeting subjects. Each meeting schedule may include an agenda, a resource device list, and a meeting participant list. The agenda may include a start time and a finish time of a meeting. The resource device list may record the at least one resource device which may be used in the meeting. The at least one resource device may include, for example, one or more of a projector, a phone, and a camera. The participant list may include name and contact information of expected participants.

The authorization manager 14 may generate an authorization key according to each meeting schedule. The authorization manager 14 may provide the authorization key to the at least one resource device, and the participants for the corresponding meeting schedule.

The control module 16 may establish the virtual private network when reach the start time according to the agenda, and dismiss the virtual private network when the time is up according to the agenda. The virtual private network may group the at least one resource device, and a plurality of clients with the authorization key. A client without an authorization key cannot access the virtual private network. The client may include a personal computer, a notebook computer, or a portable electronic device. The virtual private network may be remotely accessed through the Internet. The virtual private network may work based on a uniform protocol service.

In one embodiment, each client 30 may include a graphic user interface (GUI) module 32, a schedule event manager 34, and group network manager 36. The schedule event manger 34 may synchronize with the event schedule module 12 to keep track of the latest schedule. The group network manager 36 may control the at least one resource device and may communicate and share files with other clients in the virtual private network.

In one embodiment, the resource device 60 may include a projector and a camera. The projector may include an event schedule manager 62 and a group network manager 64. The event schedule manager 62 may synchronize with the event schedule module 12 to keep track of the latest schedule and confirm that the projector is available and reserved for use in one virtual private network. The group network manager 64 may set the projector to be controlled by only one client at one time.

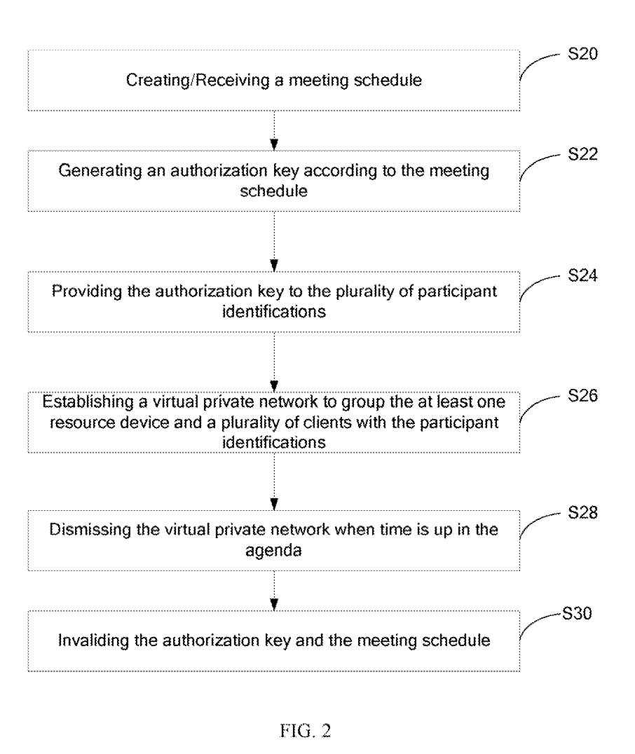

Referring to FIG. 2, a computer-implemented method for establishing a virtual private network may include the following steps.

Block S20, creating or receiving a meeting schedule. The meeting schedule includes an agenda, a resource device list recording at least one resource device, and a meeting participant list including a plurality of participant identifications.

Block S22, generating an authorization key according to the meeting schedule.

Block S24, providing the authorization key to the plurality of participant identifications.

Block S26, establishing a virtual private network to group the at least one resource device and a plurality of clients with the participant identifications when reach a start time according to the agenda. The plurality of clients may control the at least one resource device.

Block S28, dismissing the virtual private network when time is up according to the agenda. At this time, the plurality of clients cannot control the at least one resource device.

Block S30, invaliding the authorization key and the meeting schedule after dismissing the virtual private network.

While the present disclosure has been illustrated by the description of the embodiments thereof, and while the embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A server, comprising:
an event schedule module, adapted to establish a meeting schedule;
an authorization manager adapted to provide an authorization key, and a plurality of participant identifications recorded in the meeting schedule; and
a control module adapted to establish a virtual private network according to the meeting schedule, the virtual private network is adapted to group at least one resource device and a plurality of clients accessible for the virtual private network with the authorization key.

2. The server of the claim 1, wherein the authorization key comprises a share license adapted to share documents for participant identifications.

3. The server of the claim 1, wherein the authorization key comprises an operation license adapted to operate the at least one resource device.

4. The server of the claim 1, wherein the at least one resource device comprises a projector.

5. The server of the claim 1, wherein the authorization key is particularly used for the meeting schedule.

6. The server of the claim 1, wherein the control module is adapted to dismiss the virtual private network when time is up according to the meeting schedule.

7. The server of the claim 1, wherein the authorization key and the meeting schedule are invalid when the virtual private network is dismissed.

8. A computer-implemented method, comprising:
receiving a meeting schedule;
generating an authorization key according to the meeting schedule;
providing the authorization key to a plurality of participant identifications recorded in the meeting schedule;
establishing a virtual private network to group at least one resource device and a plurality of clients accessible for the virtual private network with the participant identifications when a start time in the meeting schedule is reached, and allowing the plurality of clients to control the at least one resource device; and
dismissing the virtual private network when time is up according to the meeting schedule.

9. The method of the claim 8 further comprising:
invaliding the authorization key and the meeting schedule after dismissing the virtual private network.

10. The method of the claim 8, wherein the authorization key comprises a share license for sharing documents for participant identifications.

11. The method of the claim 8, wherein the authorization key comprises an operation license for operating the at least one resource device.

12. The method of the claim 8, wherein the at least one resource device comprises a projector.

13. A computer-implemented method, comprising:
providing an event schedule module adapted to establish a meeting schedule; an authorization manager, adapted to provide an authorization key, and a plurality of participant identifications recorded in the meeting schedule; and a control module, adapted to establish a virtual private network according to the meeting schedule, the virtual private network is adapted to group at least one resource device, and a plurality of clients accessible for the virtual private network with the authorization key;
receiving the meeting schedule;
generating the authorization key according to the meeting schedule;
providing the authorization key to a plurality of participant identifications recorded in the meeting schedule;
establishing the virtual private network to group the at least one resource device and the plurality of clients with the participant identifications when reach a start time in the meeting schedule is reached, and allowing the plurality of clients to control the at least one resource device; and
dismissing the virtual private network when time is up according to the meeting schedule.
